(19) United States
(12) Patent Application Publication
(10) Pub. No.: US 2005/0284417 A1
(43) Pub. Date: Dec. 29, 2005

(54) Device for cooling and moistening sea mammal

(75) Inventor: Judith Jezl, Friendswood, TX (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: Animal Capture Equipment, Inc., Bacliff, TX (US)

(21) Appl. No.: 10/877,126

(22) Filed: Jun. 25, 2004

(51) Int. Cl. A01K 13/00

(52) U.S. Cl. 119/850

(57) ABSTRACT

A device for cooling a cetacean using a cooling fluid and for moistening the cetacean using a moistening fluid from a source includes a cooling system, a pump, and a plurality of covers. The cooling system cools the cooling fluid and can be a powered refrigeration system or a reservoir filled with ice. The pump is connected to the cooling system and pumps the cooling fluid through the plurality of covers. The covers include a body cover, a fin cover, and a tail cover. The body cover can be formed from a plurality of panels that are attachable to one another. Each cover has channels or tubing for conveying the cooling fluid throughout the cover and adjacent the cetacean. Each cover also has a drip line for releasing the moistening fluid onto the cetacean. The drip line can connect to a reservoir of fluid, which can be moved through the drip line through siphoning or by a pump.

### FIELD OF THE INVENTION

The subject matter of the present disclosure generally relates to a device for cooling and moistening sea mammals, such as such as a cetacean or manatee, and more particularly relates to a device for a sea mammal that has become stranded and requires medical assistance by cooling the animal with a plurality or covers and moistening the animal with a fluid.

### BACKGROUND OF THE INVENTION

Sea mammals include cetaceans, manatees, dugongs, walruses, and seals. Cetaceans are large, carnivorous aquatic sea mammals, including whales, dolphins, porpoises, and narwhals. Manatees are sirenian sea mammals of tropical coastal waters of America. It is not fully understood why some cetaceans become stranded on a beach. In some instances, the sea mammals may become disoriented. In other instances, for example, killer whales may become accidentally stranded when they chase prey into shallow waters. During one mass stranding of 14 killer whales in northern Norway, it is thought that the whales became stranded while chasing herring. All 14 were successfully pulled back into the water and swam off to rejoin their herd a short time later.

Unfortunately, a beached whale is normally found dead by the time human help has arrived. Rescuing a stranded whale is extremely difficult, and the whale unfortunately dies in most cases despite attempts to help them. Conventional techniques for rescuing and transporting beached or standing cetacean use towels, blankets, buckets, and misters. For a beached whale, for example, several people must continuously apply seawater to the towels on the whale to keep it moist and cool. When several whales become beached at the same time, the labor involved in conventional techniques makes rescuing the whales almost impossible. In addition, the tide may lower while the whale is beached, and the source of seawater may then be some distance from the sea mammal. Furthermore, the cetaceans may become beached in a hard to reach area, further hindering rescue efforts. The survival rate of beached sea mammals is very low, and death usually results from overheating and suffocation.

In rescuing a beached whale, it is important to ensure that the whale is not crushed under its own weight. Out of the ocean, the weight of the whale causes the rib cage to collapse, which suffocates the sea mammal. To protect the whale from its own mass, sand pits may be dug under each pectoral fin for distributing the weight of the sea mammal more evenly. In addition, the whale must be kept wet by continuous bathing, gentle hosing, or sponging. The blowhole of the whale must be kept clear, as it is the whale's only method of breathing. Furthermore, the whale must be kept cool. When out of the water, the whale cannot maintain correct body temperature, and a rapid rise in body temperature will result in death in a few hours. Typically, rescuers pour buckets of seawater over the skin to ensure it stays cool and wet, making sure to avoid pouring water in the blowhole. In addition, rescuers may cover exposed areas of the skin with water-soaked materials to keep the sea mammal cool and help prevent sun exposure.

In most instances when a whale becomes stranded, the rescuers must wait for the tide to come in so that the whale can be re-floated in the water. Even though a whale may be re-floated, rescuers must stay with the sea mammal and keep the blowhole above water, until the sea mammal can swim under its own power. Unfortunately, the whale typically beaches itself again almost immediately. In some instances, rescuers attempt to transport the whale to a facility having a large enough tank where the sea mammal can be rehabilitated. For example, the whale can be placed on a flatbed truck and kept alive with water being poured on the sea mammal to keep it cool.

The subject matter of the present disclosure is directed to overcoming, or at least reducing the effects of, one or more of the problems set forth above.

### BRIEF DESCRIPTION OF THE DRAWINGS

The foregoing summary, a preferred embodiment, and other aspects of subject matter of the present disclosure will be best understood with reference to a detailed description of specific embodiments, which follows, when read in conjunction with the accompanying drawings, in which:

FIG. 1 illustrates a cetacean having a cooling device according to certain teachings of the present disclosure.

FIG. 2 illustrates a schematic view of an embodiment of the disclosed cooling device for cooling a cetacean.

FIGS. 3A-3E illustrate various views of a cover portion of the disclosed cooling device.

FIGS. 4A-4D illustrate various views of a fin portion of the disclosed cooling device.

FIGS. 5A-5D illustrate various views of a tail portion of the disclosed cooling device.

FIGS. 6A-6B illustrates various view of a base of the disclosed cooling device.

FIG. 7 illustrates an embodiment of a cooling and pump system for the disclosed cooling device.

FIG. 8 illustrates another embodiment of a cooling and pump system for the disclosed cooling device.

FIG. 9 illustrates another embodiment of a cooling and pump system for the disclosed cooling device.

FIG. 10 illustrates a storage, cooling, and pump unit for the disclosed cooling device.

While the disclosed cooling device for sea mammals is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. §112.

### DETAILED DESCRIPTION

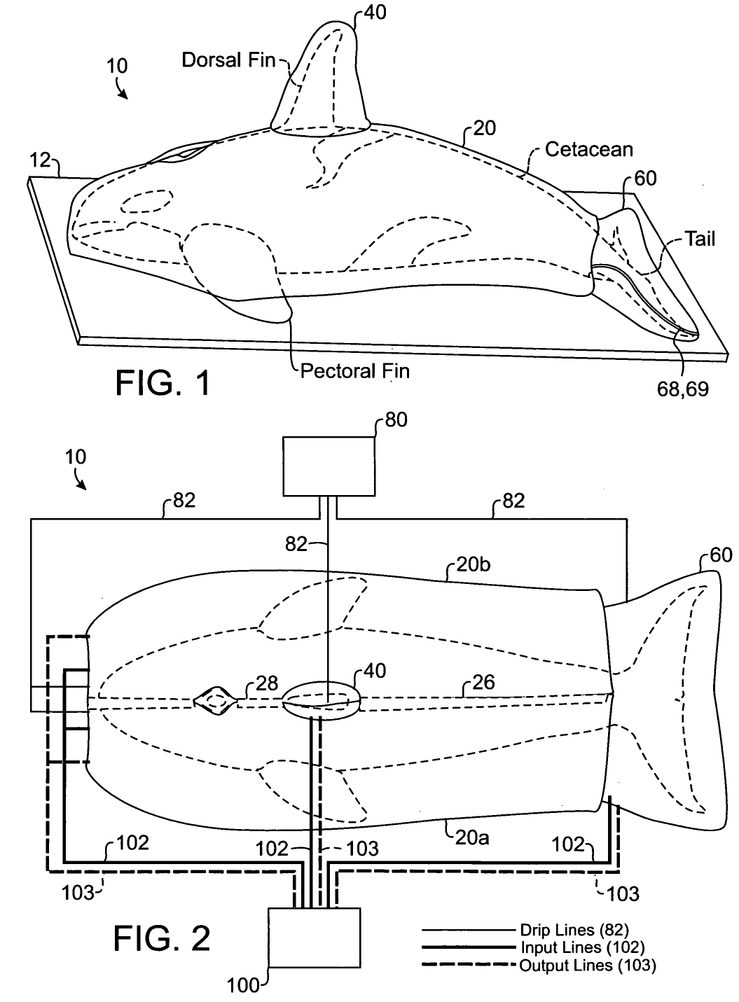

Referring to FIG. 1, an embodiment of a cooling device 10 for a sea mammal according to certain teachings of the present disclosure is illustrated. For illustrative purposes, the sea mammal referred to in the present disclosure is a cetacean, such as whale, dolphin, porpoise, or narwhal. It will be appreciated that the disclosed cooling device 10 is not limited to use with cetaceans only, but the device 10 can be used with other sea mammals, such as manatees, dugongs, walruses, and seals.

The disclosed cooling device 10 includes a base 12, a body cover 20, a fin cover 40, and a tail cover 60, among other components described in more detail below. The body cover 20 is draped over the sea mammal. The fin cover 40 is positioned on the dorsal fin, if present on the sea mammal, and the tail fin 60 is positioned on the flukes of the tail. The body cover 20, therefore, has an opening for the dorsal fin and the tail of the sea mammal. In addition, the body cover 20 has an opening for the blowhole of the sea mammal, if present. The base 12 can be used to support the sea mammal and to collect fluid, as described in more detail below.

The disclosed cooling device 10 provides an out of water environment to cool sea mammals and to moisten their skin. The disclosed cooling device 10 can be used when rescuing a stranded or beached sea mammal and can be used to transport sea mammals between locations. The disclosed cooling device 10 can be used when rescuing or transporting a sea mammal. For example, the disclosed cooling device 10 can be used when rescuing a stranded whale on a beach. The body cover 20 provides moisture and cooling to the body of the sea mammal. Similarly, the fin cover provides moisture and cooling to the dorsal fin, if present, and the tail cover provides moisture and cooling to the sea mammal's flukes. The dorsal fin (if present) and the fluke of sea mammals typically have specific cooling requirements, as these portions of the body are used to expel heat. Therefore, the disclosed cooling device 10 preferably includes separate fin and tail covers 40 and 60 for cooling these special parts of the sea mammals.

In one embodiment, the body cover 20 can be a unitary piece large enough to substantially cover the body of the sea mammal. Such a unitary body cover 20 may be suitable for a smaller sea mammal, such as a dolphin. However, the body cover 20 preferably includes at least two portions that attach together to cover the body of the sea mammal, because cetaceans such as whales can be rather large or can have various sizes.

Referring to FIG. 2, the disclosed cooling device 10 is schematically illustrated in a plan view. Again, the disclosed cooling device 10 includes the body cover 20, the fin cover 40, and the tail cover 60. In a preferred embodiment, the body cover 20 includes a plurality of pieces that fit together to cover the marine sea mammal. In the present embodiment, the body cover 20 includes a first portion or left panel 20a and a second portion or right panel 20b. Use of two panels 20a-b is preferred for larger sea mammals instead of a single body cover. As described in more detail below, the panels 20a-b of the cover 20 have fasteners along the edges so that the panels 20a-b can be attached together to substantially cover the sea mammal. For example, the upper edges of the side panels 20a-b can have mating strips of Velcro fasteners 26, 28. Some of the Velcro fasteners 28 can be left open near the location of the sea mammal's blowhole to allow the sea mammal to breath. As also described in more detail below, the fin cover 40 and tail cover 60 also preferably have fasteners (not shown), such as Velcro, which allow the covers 40 and 60 to attach to the panels 20a-b and to stay on the sea mammal.

In a preferred embodiment, the disclosed cooling device 10 also includes a moisture apparatus 80 and a circulating system 100. In one embodiment, the moisture apparatus 80 includes a reservoir for moistening fluid. The moistening fluid can be salt water or fresh water, whichever is suitable for the sea mammal. The reservoir of the moisture apparatus 80 is connected to inlet valves or ports on the body panels 20a-b, the fin cover 40, and the tail cover 60 via drip lines 82. In one embodiment, the moistening fluid can travel from the reservoir to the covers 20, 40, 60 by siphoning. In another embodiment and especially for larger sea mammals, the moisture apparatus 80 can further include a pump for pumping the moistening fluid from the reservoir to the covers 20, 40, and 60. The moisture apparatus 80 moves the moistening fluid to the sea mammal to keep its skin moist, which is important for the survival of sea mammals when stranded or transported.

The circulating system 100 provides cooling for the sea mammal by cooling a cooling fluid and pumping the cooling fluid to and from each of the covers 20, 40, and 60 via inlet and outlet interconnect lines 102 and 103. In one embodiment, the circulating system 100 described in more detail below includes a refrigeration system (not shown) for cooling the cooling fluid and includes a marine bilge pump (not shown) for pumping the cooling fluid through the device 10.

As noted above, the disclosed cooling device 10 has two body panels 20a-b that attach together over the head and body of the sea mammal. When the panels 20a-b are positioned on the sea mammal, an opening for the dorsal fin and the blowhole (if present on the sea mammal) are formed with the body panels 20a-b. The fin cover 40 then positions on the dorsal fin of the sea mammal and attaches to the fasteners 26 at the opening of the body panels 20a-b. Likewise, the tail cover 60 positions on the flukes of the sea mammal's tail near the open end of the body panels 20a-b.

After the side panels 20a-b, fin cover 40, and tail cover 60 are attached, the circulating system 100 is connected to the inlet and outlet valves of the covers 20, 40, and 60 via interconnect lines or hoses 102 and 103. The pump of the circulating system 100 then pumps cooling fluid through circuits, such as channels or tubing (not shown), within the covers 20, 40, and 60 to keep the animal cool. For the body of the sea mammal, the channels or tubing of the side panels 20a-b preferably make the cooling fluid travel from the head of the sea mammal toward the tail and from the back of the sea mammal toward the stomach. For the dorsal fin, the channels or tubing in the fin cover 40 preferably make the cooling fluid travel from the base of the dorsal fin towards the distal end of the fin. For the tail of the sea mammal, the channels or tubing of the tail cover 60 preferably makes the cooling fluid travel from the base of the tail towards the ends of the flukes.

While traveling through the covers 20, 40, and 60, the cooling fluid absorbs heat from the sea mammal. The cooling fluid can be water, a saline solution, or other aqueous solution. For example, a saline solution may be desirable for ocean cetaceans if the cooling fluid where to inadvertently leak onto the sea mammal from the covers 20, 40, or 60. After cooling the sea mammal, the heated fluid exits the outlet valves of the covers 20, 40, and 60 and travels through the interconnecting lines 103 to the circulating system 100. The circulating system 100 then expels the heat to the environment, cools the cooling fluid, and again pumps the fluid to the covers 20, 40, and 60 to continue the cooling process.

After the side panels 20a-b, fin cover 40, and tail cover 60 are attached, the moistening device 80 is also connected to inlet valves or ports of the covers 20, 40, and 60 via drip lines 82. The moistening fluid can be distributed to the covers 20, 40, and 60 through siphoning. If the sea mammal is relatively large, a small pump can be used to move the moistening fluid to the covers 20, 40, and 60. Once distributed to the covers 20, 40, and 60, the moistening fluid drips from drip lines (not shown) within the covers 20, 40, and 60 onto the skin of the sea mammal to keep the skin moist. The arrangement of the drip lines within the covers 20, 40, and 60 preferably makes the moistening fluid travel from the head of the sea mammal toward the tail.

For illustrative purposes, details of various cetaceans are discussed below. The values provided below are intended to guide those skilled in the art to the appropriate sizes of covers 20, 40, and 60 for the disclosed cooling device 10 to meet the particular needs of a type of cetacean. Male killer whales or Orcinus orca, for example, average 5.8 to 6.7 m (19-22 ft.) and usually weigh between 3,628 and 5,442 kg (8,000-12,000 lbs.). Female killer whales or cows average 4.9 to 5.8-m (16 to 19-ft.) and usually weigh between 1,361 and 3,628-kg (3,000-8,000 lbs.). Individual sizes vary significantly between geographical areas. Length estimates for more than 2,000 killer whales taken by North Atlantic whaling operations show male North Atlantic killer whales average about 6.1-m (20-ft.) while females average about 5.5-m (18-ft.). The dorsal fins of male killer whales are the tallest of any cetacean in the world, growing up to 1.8-m (6-ft.). Female dorsal fins are smaller at about 0.9 to 1.2-m (3 to 4-ft.) and may be slightly curved back. Each lobe of the tail is called a fluke. Flukes of a male killer whale have been measured to be as much as 2.7-m (9-ft.) from tip to tip.

Dolphins, Dlephinindae, can average about 1.2-m to 1.8-m in length. Male sperm whales reach lengths of 15 to 18-m (49 to 59-ft.) and weigh up to 31,750 to 40,800-kg (35 to 45 tons). Adult females are much smaller, growing to about 11-m (36-ft.) and a maximum weight of 12,000 to 12,700-kg (13 to 14 tons). Adult West Indian and West African manatees average about 3-m (10-ft.) in length. Average adult manatees weigh approximately 363 to 544-kg (800 to 1200-lbs). Amazonian manatees are the smallest of the three species. They are shorter and more slender.

Given these values for various sea mammals, the panels of the body cover 20 can have different sizes to suit the various sizes. For cetaceans, for example, the panels of the body cover 20 can have two sizes, such as 42-inches by 72-inches and 42-inches by 120-inches. A plurality of panels can be used on lager sea mammals by attaching the panels together according to techniques described below. For dolphins, the fin cover 40 and tail cover 60 can each have two sizes suitable to the size range of various dorsal fins and tail flukes of dolphins. For whales, the fin cover 40 and tail cover 60 can each have three sizes suitable to the size range of various dorsal fins and tail flukes of whales. For manatees, which lack a dorsal fin, the fin cover 40 can have two sizes suitable to the size range of various tail flukes of manatees.

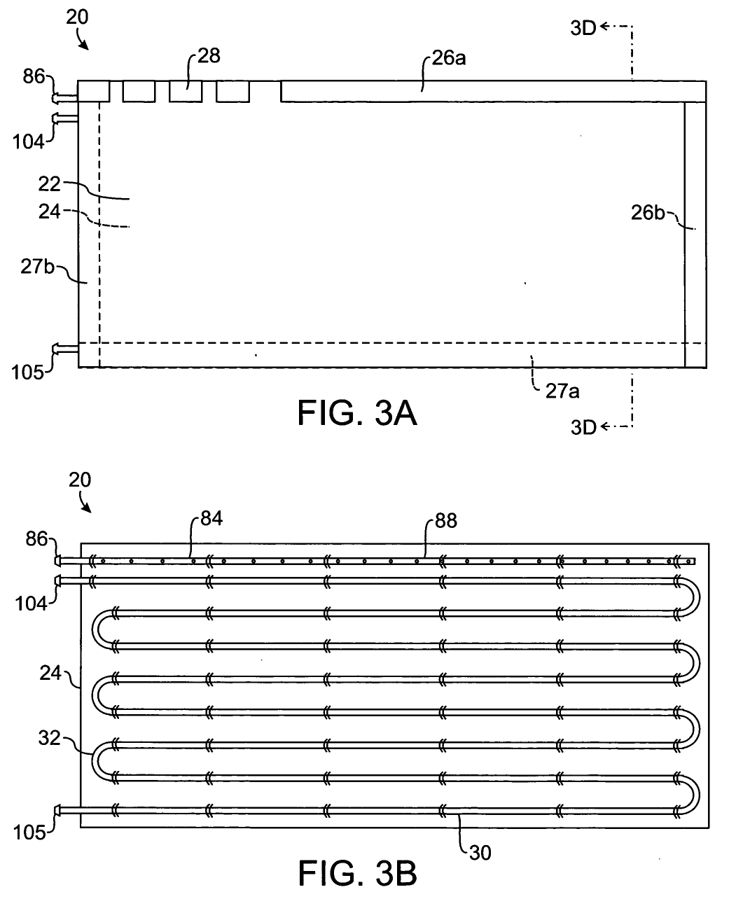

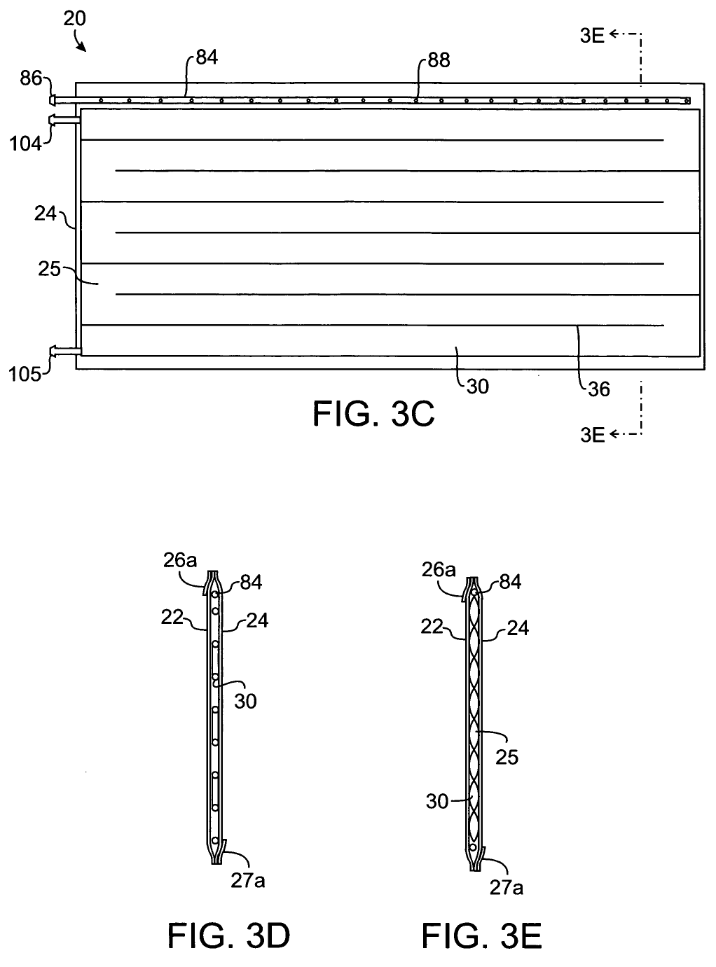

Referring to FIGS. 3A-3E, embodiments of cover panels 20 for the disclosed cooling device 10 are illustrated in various views. In FIG. 3A, an external view of an embodiment of a cover panel 20 is shown, and a cross-section of the disclosed cover panel 20 is also shown. The cover panel 20 has an inside surface 22, an outside surface 24, inside fasteners 26a-b, and outside fasteners 27a-b. In addition, the cover panel 20 has a drip line 84 and cooling channels or tubing 30 positioned between the inside and outside surfaces 22 and 24, as best shown in FIG. 3D.

For cetaceans, the cover panel 20 can be 72-inches or 120-inches along the longitudinal edges and can be preferably 42-inches along the shorter, lateral edges. The dimensions for the panel 20 can vary depending on the sea mammal for which it is indented. The inside surface 22 is preferably composed of fabric, such as flannel, or other material for holding moisture. The outside surface 24 is preferably composed of a durable material that can hold in moisture and cooling, such as plastic. Outer edges of the surfaces 22 and 24 are attached together. For example, the edges can be sewn together.

As shown in FIG. 3A, first fasteners 26a-b are attached on the inside surface 22 of the body panel 20. A top fastener 26a is attached along the top, longitudinal edge of the cover panel 20, and a side fastener 26b is attached along one of the shorter, lateral edges of the cover panel 20. Second fasteners 27a-b are attached on the outside surface 24 of the body panel 20. A bottom fastener 27a is attached along the bottom, longitudinal edge of the panel 20, and a side fastener 27b is attached along one of the shorter, lateral edges of the cover panel 20. Intermittent fasteners 28 are attached to the inside surface 22 also along the top, longitudinal edge of the panel 20.

The fasteners 26, 27, and 28 allow the one panel 20 to be attached to other like-formed panels 20 to make a larger cover for substantially covering a sea mammal. For example, the top fasteners 26a and 28 can attach to the bottom fastener 27a of another panel 20, and the side fastener 26a can attach to the side fastener 27b of another panel 20.

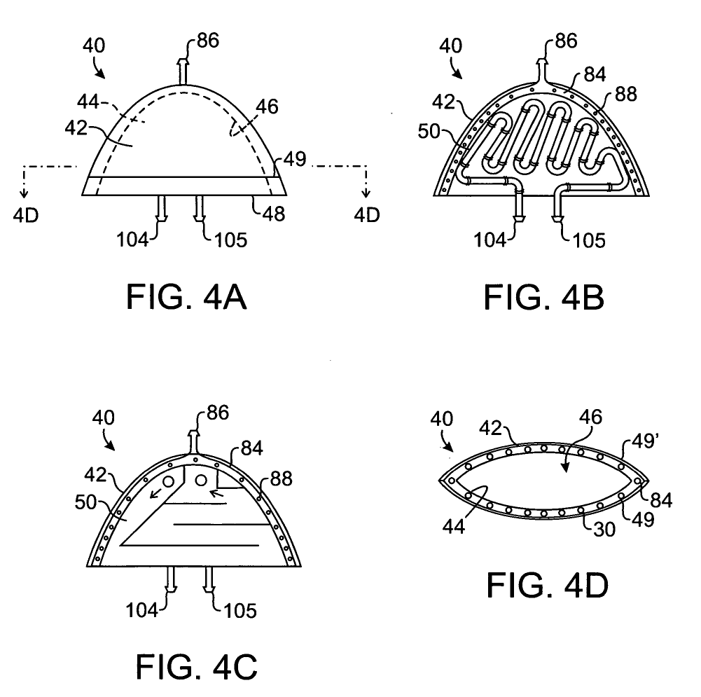

In addition, panels 20 can be formed for right and left sides of the mammals so that top fasteners 26a and 28 for a right panel 20 can mate with top fasteners 26a and 28 of a left panel 20. The intermittent fasteners 28 allow the formation of an opening for the blowhole of a cetacean when positioned over the animal. The upper fastener 26a can also attach to fasteners on the fin cover (40 of FIG. 4A), as described below.

The fasteners 26, 27, and 28 are preferably formed from industrial grade VELCRO stitched onto the inside and outside surfaces 22 and 24 of the cover panel 20. Therefore, the top fasteners 26a, 28 and the bottom fasteners 27a are preferably corresponding portions of VELCRO, and the side fasteners 26b and 27b are also preferably corresponding portions of VELCRO. Furthermore, the right and left side panels 20 intended to attach on either side of a sea mammal also have corresponding portions of VELCRO attached along their upper edges.

In FIG. 3B, an internal view of the cover panel 20 shows the inside surface removed to reveal the tubing 30 and the drip line 84. The tubing 30 is circuited throughout the cover panel 20 for conveying the cooling fluid. The tubing can be 3/16-inch medical grade vinyl hose or other flexible hose. Depending on the size of the sea mammal intended for the cooling device and the amount of fluid to be conveyed through the tubing 30, the diameter of the tubing can vary. The tubing 30 is illustrated in FIG. 3B with seven turns 32 for illustrative purposes. It will be appreciated that more or less turns can be provided in the tubing to increase or decrease the amount of surface area that the tubing 30 covers on the panel 20.

The tubing 30 is attached to the panel cover 20. In one embodiment, the tubing 30 is sewn to the inside surface (not shown) and the outside surface 24 at a plurality of attachment points 34, but other techniques known in the art can be used to attach the tubing 30 to the panel cover 20. Any bends 32 of the tubing 30 are preferably formed to substantially prevent kinking of the tubing 30. For 3/16-inch medical grade vinyl hose, for example, the tubing 30 is bent at a minimum of 4-inch radius.

One end of the tubing 30 connects to an inlet valve or port 104 that attaches to the circulating system, while another end of the tubing 30 connects to an outlet valve or port 105 that attaches to the circulating system. The inlet and outlet valves 104 and 105 can be any conventional quick connect for connecting tubing. When connected to the circulating system (100 of FIG. 2), cooled fluid is pumped through the tubing 30 from the inlet valve 104 to the outlet valve 105. The cooling fluid absorbs heat from the sea mammal while traveling through the tubing 30 and conveys the heat to the circulating system. Preferably, the cooling fluid flows through the tubing 30 from the top edge of the cover panel 20 to the bottom edge so that cooling of the cetacean occurs from the dorsal area of the sea mammal and down its sides toward the stomach.

The cover panel 20 also includes the drip line 84 having an inlet valve or port 86 and a plurality of holes 88 formed along the length of the drip line 84. As best shown in FIG. 3A, the drip line 84 is also positioned in between the inside and outside surfaces 22 and 24 of the cover 20. The drip line 84 is attached along the upper longitudinal edge of the panel 20 and can be sewn to the surfaces 22 and 24. As shown in FIG. 3B, the holes 88 are formed along the length of the drip line 84 so that fluid entering the line 84 from the inlet valve or port 86 travels along the line 84 and drips from the holes 88. Preferably, either more holes 88 or larger holes 88 are formed towards the end of the drip line 84 away from the inlet valve 86. In this way, fluid can substantially travel the along the entire length of the line 84.

In an alternative embodiment of the cover panel 20 shown in FIGS. 3C-3D, the cover panel 20 includes channels 30 instead of tubing for conveying the cooling fluid. In the present embodiment, a two-ply material 25 having longitudinal separations 36 formed in the material forms the channels 30 for conveying the cooling fluid. For example, the two-ply material 25 can be sheets of plastic that are heat sealed along the outer edges and heat sealed to form the longitudinal separations 36. The two-ply material 25 can be attached to the surface 22 or 24 by sewing or other techniques. The channels 30 connect to the inlet and outlet valves 104 and 105 and preferably convey the cooling fluid from the top of the panel 20 to the bottom of the panel 20.

Referring to FIGS. 4A-4E, embodiments of a fin cover 40 are illustrated in various views. In FIG. 4A, an external view of the fin cover 40 is shown. The fin cover 40 has an inside surface 42 and an outside surface 44. In FIG. 4E, a cross-section of the fin cover is shown. The fin cover 40 is generally formed in the shape of a dorsal fin of a cetacean. Thus, the fin cover 40 has an inner pocket 46 for positioning the dorsal fin and an open side 48 for inserting the dorsal fin. Fasteners 49 and 49′ are attached on either side of the cover 40 along the open end 48. When the fin cover 40 is positioned on the dorsal fin of the sea mammal, the fasteners 49 and 49′ attach to upper fasteners (26a of FIG. 3A) of side cover panels (20 of FIG. 3A) when the fin cover 40 is positioned on the dorsal fin of the cetacean. The fasteners 49 and 49′ are preferably formed from industrial grade VELCRO stitched onto the outside surface 44 of the fin cover 40.

The size of the fin cover 40 depends on the dorsal fin of the cetacean for which it is intended. In general, the fin cover 40 can have two sizes for dolphins and three sizes for whales. The inside surface 42 is preferably composed of fabric, such as flannel, or other material for holding moisture. The outside surface 44 is preferably composed of a durable material that can hold in moisture and cooling, such as plastic. As discussed below with reference to FIG. 4B and 4C, the fin cover 40 has cooling channels or tubing 50 positioned between the inside and outside surfaces 42 and 44.

In FIG. 4B, one side of the fin cover 40 is shown removed, and the inside surface of the remaining side of the fin cover 40 is also shown removed. FIG. 4B reveals the tubing 50 and drip line 84 of one side of the fin cover 40. The tubing 50 is circuited throughout the side of the fin cover 40 for conveying the cooling fluid adjacent the dorsal fin. The tubing 50 can be 3/16-inch medical grade vinyl hose or other flexible hose. Depending on the size of the cetacean intended for the cooling device and the amount of fluid to be conveyed through the tubing 50, the diameter of the tubing 50 can vary. The tubing 50 is illustrated in FIG. 4B with a number of turns 52 for illustrative purposes. It will be appreciated that more or less turns can be provided in the tubing to increase or decrease the amount of surface are that the tubing 50 covers.

The tubing 50 is attached to the fin cover 40. In one embodiment, the tubing 50 is sewn to the inside and outside surfaces 44 at a plurality of attachment points 54, but other techniques known in the art can be used to attach the tubing 50 to the fin cover 40. Any bends 52 of the tubing are preferably formed to substantially prevent kinking of the tubing 50. For 3/16-inch medical grade vinyl hose, the tubing 50 is bent at a minimum of 4-inch radius.

One end of the tubing 50 connects to an inlet valve or port 104 that attaches to the circulating system, while another end of the tubing 50 connects to an outlet valve or port 105 that also attaches to the circulating system. The inlet and outlet valves 104 and 105 can be any conventional quick connect for connecting tubing. When connected to the circulating system (100 of FIG. 2), cooled fluid is pumped through the tubing 50 from the inlet valve 104 to the outlet valve 105. The cooling fluid absorbs heat from the sea mammal's dorsal fin while traveling through the tubing 50 and conveys the heat to the circulating system. Preferably, the cooling fluid flows through the tubing 50 across the fin cover 40.

The fin cover 40 also includes the drip line 84 having an inlet valve or port 86. The drip line 84 branches along both edges of the fin cover 40 and has a plurality of holes 88 formed along the lengths of the branched drip line 84. The holes 88 are formed so that the fluid entering the drip line 84 from the inlet valve or port 86 travels along the line 84 and drips from the holes 88. Preferably, either more holes 88 or larger holes 88 are formed towards the end of the drip line 84 away from the inlet valve 86. In this way, fluid can substantially travel the along the entire length of the line 84. Fluid entering the drip line 84 from the inlet valve 86 is conveyed across the top of the cetacean's dorsal fin and is allowed to drip out of the holes 88 onto the dorsal fin.

In an alternative embodiment of the fin cover 40 shown in FIG. 4C, the fin cover 40 includes cooling channels 50 instead of tubing for conveying the cooling fluid. In the present embodiment, a two-ply material 45 having longitudinal separations 47 formed in the material forms the channels 50 for conveying the cooling fluid. For example, the two-ply material 25 can be sheets of plastic that are heat sealed along the outer edges and heat sealed to form the longitudinal separations 56. The channels 50 preferably connect to the inlet and outlet valves 104 and 105 near to top of the fin cover 40. Preferably, the channel 50 conveys the cooling fluid from the bottom of the cover 40 to the top of the cover 40.

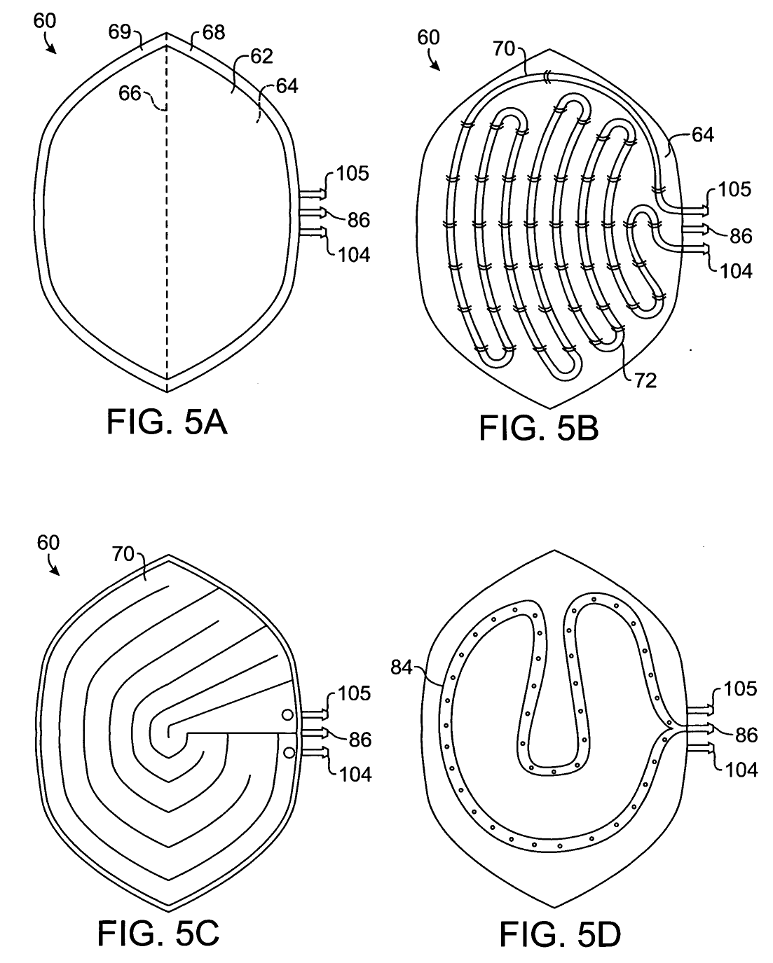

Referring to FIGS. 5A-5D, embodiments of a tail cover 60 are illustrated in various views. In FIG. 5A, an external view of a tail cover 60 is shown. The tail cover 60 has an inside surface 62 and an outside surface 64. The tail cover 60 is generally formed to cover the flukes of a sea mammal's tail. Portion of the tail cover 60 positions under the flukes. The tail cover 60 then folds along line 66 so that the other portion of the tail cover 60 covers the top of the flukes. A first fastener 68 is attached to the inside surface 62 of the tail cover 60 around the outer edge of the cover 60 on one side of the fold 66, and a second fastener 69 is attached to the inside surface 62 of the tail cover 60 around the outer edge of the cover 60 on the other side of the fold 66. When the tail cover 60 is folded over the flukes of the sea mammal, the fasteners 68 and 69 attach together. The fasteners 68 and 69 are preferably corresponding portions of industrial grade VELCRO stitched onto the inside surface 62 of the tail cover 60.

The size of the tail cover 60 depends on the flukes of the cetacean for which it is intended. In general, the tail cover 60 can have two sizes for dolphins, three sizes for whales, and two sizes for manatees. The inside surface 42 is preferably composed of fabric, such as flannel, or other material for holding moisture. The outside surface 44 is preferably composed of a durable material that can hold in moisture and cooling, such as plastic. Edges of the surfaces 62 and 64 can be sewn together, and the fasteners 68 and 69 can be sewn along the edges as well.

As discussed below with reference to FIG. 5B and 5C, the tail cover 60 has cooling channels or tubing 70 positioned between the inside and outside surfaces 62 and 64. In FIG. 5B, an internal view of the tail cover 60 shows the inside surface removed to reveal tubing 70. The tubing 70 is circuited throughout tail cover 60 for conveying the cooling fluid. The tubing 70 can be 3/16-inch medical grade vinyl hose or other flexible hose. Depending on the size of the cetacean intended for the cooling device and the amount of fluid to be conveyed through the tubing 70, the diameter of the tubing 70 can vary. The tubing 70 is illustrated in FIG. 4B with a number of turns 72 for illustrative purposes. It will be appreciated that more or less turns can be provided in the tubing to increase or decrease the amount of surface are that the tubing 70 covers.

The tubing 70 is attached to the tail cover 60. In one embodiment, the tubing 70 is sewn to the inside and outside surfaces 62 and 64 at a plurality of attachment points 74, but other techniques known in the art can be used to attach the tubing 70 to the tail cover 60. Any bends 72 of the tubing are preferably formed to substantially prevent kinking of the tubing 70. For 3/16-inch medical grade vinyl hose, the tubing 70 is bent at a minimum of 4-inch radius.

One end of the tubing 70 connects to an inlet valve or port 104 that attaches to the circulating system, while another end of the tubing 70 connects to an outlet valve or port 105 that attaches to the circulating system. The inlet and outlet valves 104 and 105 can be any conventional quick connect for connecting tubing. When connected to the circulating system (100 of FIG. 2), cooled fluid is pumped through the tubing 70 from the inlet valve 104 to the outlet valve 105. The cooling fluid absorbs heat from the sea mammal's flukes while traveling through the tubing 70 and conveys the heat to the circulating system. Preferably, the cooling fluid flows through the tubing 70 from one side of the fold 66 to the other.

In an alternative embodiment of the tail cover 60 shown in FIG. 5C, the tail cover 60 includes cooling channels 70 instead of tubing for conveying the cooling fluid. In the present embodiment, a two-ply material 65 having separations 67 formed on the material forms the channels 70 for conveying the cooling fluid. For example, the two-ply material 65 can be sheets of plastic that are heat sealed along the outer edges and heat sealed to form the longitudinal separations 76. The channels 70 preferably connect to the inlet and outlet valves 104 and 105 and preferably convey the cooling fluid around the cover 60.

Referring to FIG. 5D, an external view of the tail cover 60 shows the drip line 84 on inside surface 62. The drip line 84 is attached to the inside surface 62. The drip line 84 has an inlet valve or port 86 and branches along both edges of the tail cover 60 to form a loop around the tail cover 60. Preferably, a central portion of the drip line 84 loops inwards at the fold 66 of the cover 60. The drip line 84 has a plurality of holes 88 formed along its length. The holes 88 are formed so that fluid entering the line 84 from the inlet valve 86 travels along the line and drips from the holes 88. Preferably, either more holes 88 or larger holes 88 are formed towards the end of the drip line 84 away from the inlet valve 86. In this way, fluid can substantially travel the along the entire length of the line 84. Fluid entering the drip line 84 from the inlet valve 86 is conveyed across the flukes of the cetacean's tail and is allowed to drip out of the holes 88 onto the flukes of the tail.

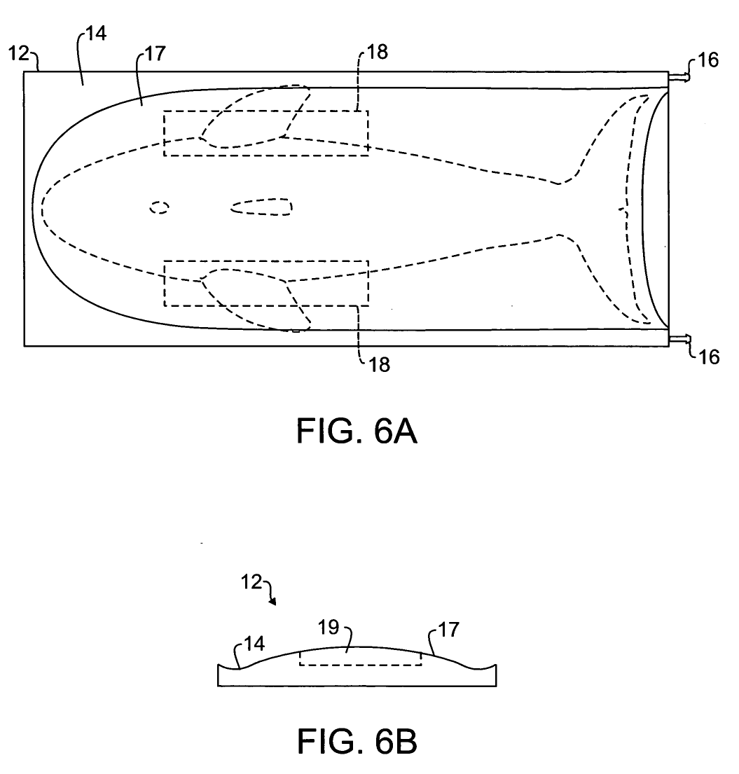

As noted above, the disclosed cooling device can include an under blanket or base. Referring to FIGS. 6A-6B, an embodiment of a base 12 for the disclosed cooling device is shown in a plan view and an end view. The base 12 can be used when transporting or rescuing a sea mammal. The base 12 is preferably composed of closed foam to prevent saturation by moistening fluid. In addition, the base 12 can have cavities filled with a gel or other aqueous solution for providing cushioning and for distributing the animal's weight. As noted above, the weight of sea mammals, such as cetaceans, when stranded out of the water can causes their rib cages to collapse, which suffocates the animal. To protect the cetacean from its own mass, rescuers typically dig sand pits under each pectoral fin to help distribute the weight of the sea mammal more evenly. Therefore, the base 12 preferably has recessed areas 18 formed near the pectoral fins of the cetacean to help distribute the sea mammal's weight and prevent suffocation. The base 12 also preferably slopes from the center to the edges such that a raised central portion 17 is formed. In addition, the center portion 17 can have a gel or aqueous filled cavity 19 to provide cushioning and distribute weight.

The base 12 also preferably has a drip channel 14 for collecting the moistening fluid dripping from the sea mammal. The drip channel 14 conveys the excess moistening fluid toward connections 16 at the end of the base 12 where the moistening fluid can be collected for recirculation if desired. The width and length of the base 12 can vary based on the size of the intended cetacean. The base 12 is preferably formed to allow natural use of pectoral and fluke fins. The base 12 can also be cooled using substantially the same techniques disclosed herein for cooling the covers. For example, the base can include tubing circuited throughout that conveys cooling fluid to and from the circulating system disclosed herein.

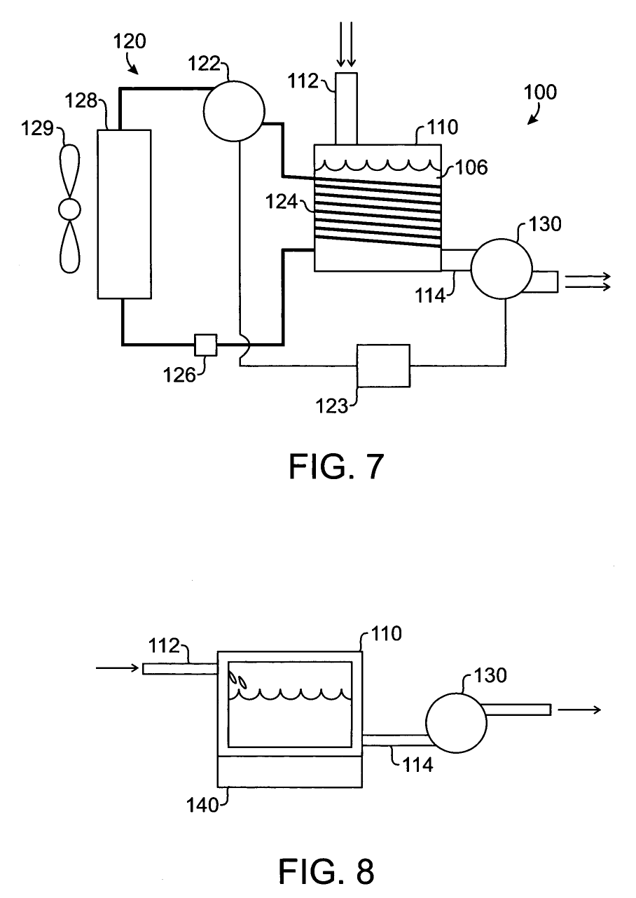

Referring to FIG. 7, an embodiment of a circulating system 100 for the disclosed cooling device for a cetacean is illustrated. The circulating system 100 includes a reservoir 110, a refrigeration system 120, and a pump 130. The reservoir 110 has an inlet 112 and an outlet 114 and holds the cooling fluid 106 for cooling the cetacean. The pump 130 connects to the outlet 114 of the reservoir 110 and pumps the cooling fluid 106 from the reservoir 110 to the cover portions of the disclosed cooling device. Various types of pumps known in the art can be used. For example, the pump 130 can be a conventional marine bilge pump commonly used in the art. In general, such bilge pumps can pump from 450 to 750-gph and can operate with DC power and low voltage, such as 1 to 5-amps and 12V. 100591 In the present embodiment, the circulating system 100 has a powered refrigeration system 120, which includes a compressor 122, an evaporator coil 124, an expansion valve 126, and a condenser 128. The condenser 128 can be air-cooled and can have a fan 129. The evaporator 124 can include a plurality of tubes and/or fins for heat transfer with the heated fluid from the cover portions of the disclosed cooling device. Briefly, the compressor 122 compresses a conventional refrigeration fluid, such as R-22 or R-12. The refrigeration fluid travels through the evaporator coil 124, which is in heat transfer relation to the cooling fluid 106 in the reservoir 110. In the present embodiment, the evaporator coil 124 wraps around the reservoir 110 in a manner typically used in water coolers or the like, but other techniques for cooling a fluid with an evaporator can be used. The refrigeration fluid absorbs heat from the cooling fluid 106 in the reservoir 110 and travels through the expansion valve 126 to the condenser 128. The fan 129 conveys air through the air-cooled condenser 128, where the refrigeration fluid is condensed. From the condenser 128, the refrigeration fluid returns to the compressor 122 to complete the refrigeration cycle.

The refrigeration system preferably has a controller 123 commonly used for such a system. The controller 123 connects to a power supply (not shown) and operates the compressor 122 and other aspects of the system 120. The power supply can be a battery, conventional AC power, or a gas-powered generator. The controller 123 can also have a temperature sensor and can monitor the cooling of the cooling fluid in the reservoir 110. The cooling device preferably has variable cooling ability because the preferred temperature of the cetaceans may vary between sea mammals and the size of the sea mammals may differ. For example, a Killer Whale is preferably exposed to an outside temperature from 30-degrees to 56-degrees Fahrenheit. However, a dolphin is preferably exposed to an outside temperature from 65-degrees to 70-degrees Fahrenheit. Although the refrigeration system 120 in FIG. 7 includes a powered compressor 122, the refrigeration system 120 can be a thermosyphon, which does not use a power compressor.

Referring to FIG. 8, an alternative embodiment of the circulating system 100 for the disclosed cooling device for a sea mammal is illustrated. The circulating system 100 includes a reservoir 110, a pump 130, and a thermoelectric subassembly or “engine” 140. The reservoir 110 has an inlet 112 and an outlet 114 and holds the cooling fluid 106 for cooling the sea mammal. The pump 130 connects to the outlet 114 of the reservoir 110 and pumps the cooling fluid 106 from the reservoir 110 to the cover portions of the disclosed cooling device. The pump 130 can be a conventional marine bilge pump commonly used in the art.

The thermoelectric subassembly or “engine” 140 is in thermal communication with the reservoir 110. The thermoelectric subassembly 140 operates on a thermoelectric principle, where a cold surface or heat sink is created electronically. The Thermoelectric subassembly or “engine” 140 includes a Peltier module (not shown), a cold sink (not shown), a hot sink (not shown), and a thermal switch (not shown). Briefly, heat moves onto the heat sink, and cold moves onto the cold sink when electrical current is passed through the subassembly 140. As current passes through the metal pillars of the heat and cold sinks, the cold electrons are forced in one direction and hot electrons are forced in the opposite direction. As the hot electrons are forced out of the inside of the reservoir, it removes the heat from the cooling fluid and allows the cold electrons to settle inside the cooler, which in turn, cool the cooling fluid.

Thermoelectric subassemblies 140 are known in the art and are used with commercially available coolers. For example, Igloo offers Kool Mate Thermoelectric Coolers, such as the Kool Mate 40. The thermoelectric coolers can operate with 12-V DC power, such as provided by a car battery. In addition, the thermoelectric coolers can cool to over 40° F. below the outside temperature.

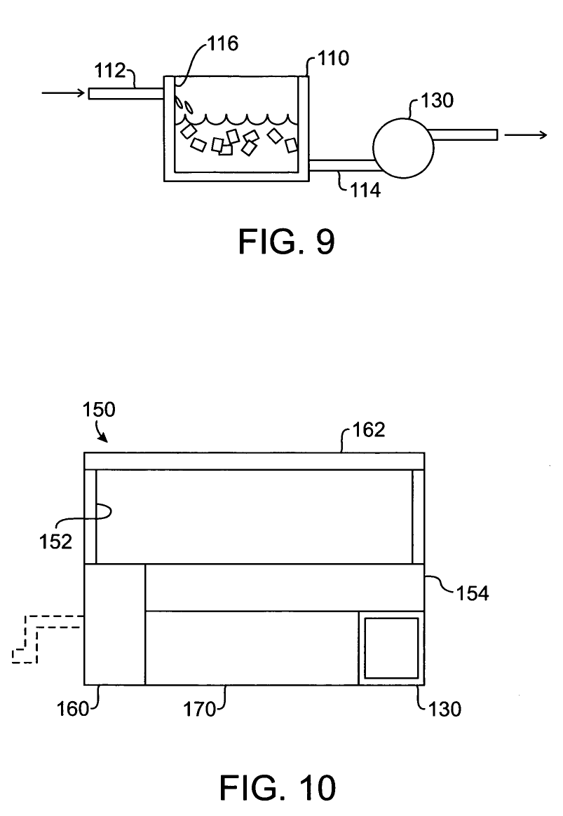

Referring to FIG. 9, an alternative embodiment of the circulating system 100 for the disclosed cooling device for a sea mammal is illustrated. The circulating system 100 includes a reservoir 110 and a pump 130. The reservoir 110 has an inlet 112 and an outlet 114 and holds the cooling fluid 106 for cooling the cetacean. The pump 130 connects to the outlet 114 of the reservoir 110 and pumps the cooling fluid 106 from the reservoir 110 to the cover portions of the disclosed cooling device. The pump 130 can be a conventional marine bilge pump commonly used in the art.

The reservoir 110 has an opening 116 where rescuers can fill the reservoir with ice to cool the cooling fluid 106 in the reservoir. The present embodiment may be suitable when rescuing a stranded cetacean and substantial power for operating a refrigeration system is not readily available. The embodiment of the refrigeration system 120 in FIG. 7 may be suitable for transporting a rescued cetacean because the refrigeration system 120 may require more power.

Referring to FIG. 10, an embodiment of a storage and cooling unit 150 is schematically illustrated. The storage and cooling unit 150 can be used to store the disclosed cooling device and to initially prepare it for use when needed. The unit 150 includes a first compartment 152 for storing the cover portions of the disclosed cooling device. The first compartment 152 can also be used to hold the cooling fluid for the device when the cover portions are positioned on the animal. The unit 150 can also includes a second compartment 154 for the interconnecting lines of the disclosed cooling device.

In addition to storage, the unit 150 holds a cooling system 170, pump 130, and a portable power supply 160. The power supply 160 can be a battery, for example. The battery power supply 160 can be connected to solar cells 162 used to charge the battery. Alternatively, the power supply 160 can include a manual generator (not shown) that is operated with a hand crank. Such hand operated manual generators are known in the art and are used to charge flashlights, for example. Rather than include a portable battery or manual generator, other power supplies can be used, such as commercial AC power if available or a gas-powered generator.

In one embodiment, the portable power supply 160 is at least capable of operating the refrigeration system 120 and pump 130 when the cover is stored in the unit 150. In this way, the cover portions can be initially cooled when being transported to rescue a sea mammal. The cooling system 170 can be a powered refrigeration system 120, such as disclosed with reference to FIG. 7. In a preferred embodiment for the portable unit 150, the cooling system 170 is a powered, thermoelectric cooler, such as disclosed above with reference to FIG. 8. The pump 130 can be a marine bilge pump operating on DC power, such as disclosed above.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A device for cooling a sea mammal using a fluid, the device comprising:
a circulating system circulating the fluid;
at least one body cover of covering at least a portion of the body of the sea mammal, the at least one body cover connected to the circulating system and conveying the fluid adjacent the sea mammal; and
at least one fin cover covering at least a portion of one of the fins of the sea mammal, the at least one fin cover connected to the circulating system and conveying the fluid adjacent the sea mammal.

2. The device of claim 1, wherein the circulating system comprises a cooling system cooling the fluid.

3. The device of claim 1, wherein the circulating system comprises a pump pumping the fluid.

4. (cancelled)

5. The device of claim 1, wherein the body and fin covers include fasteners such that the body cover is attachable to the fin cover.

6. The device of claim 1, wherein each of the covers comprises a circuit positioned on the cover, the circuit connected to the circulating system and conveying the fluid in thermal communication with the sea mammal.

7. The device of claim 1, wherein the circulating system comprises a source of the fluid for moistening the sea mammal, and wherein each of the covers comprises a circuit connected to the source and releasing the fluid onto the sea mammal.

8. (canceled)

9. A device for cooling a sea mammal using a fluid, the device comprising:
a cooling system cooling the fluid;
a pump connected to the cooling system and pumping the fluid through the device;
at least one body cover covering at least a portion of the body of the sea mammal and defining an opening for the dorsal fin of the sea mammal, the at least one body cover connected to the cooling system and the pump and conveying the fluid in thermal communication with the sea mammal; and
a dorsal fin cover covering at least a portion of the dorsal fin of the sea mammal, the dorsal fin cover connected to the cooling system and the pump and conveying the fluid in thermal communication with the sea mammal.

10. (canceled)

11. The device of claim 10, wherein the body and dorsal fin covers include fasteners such that the body cover is attachable to the dorsal fin cover.

12. The device of claim 11, wherein the fasteners include mating portions of fastening strips attached to edges of the plurality of covers.

13. (canceled)

14. The device of claim 9, further comprising a tail fin cover covering a portion of the tail fin of the sea mammal.

15. (canceled)

16. The device of claim 9, wherein each of the covers comprises a circuit positioned on the cover, the circuit connected to the pump and the cooling system and conveying the fluid in thermal communication wit the sea mammal.

17. The device of claim 16, wherein the circuit includes a tube or a channel circuited throughout the cover.

18. The device of claim 9, further comprising a source of fluid for moistening the sea mammal, wherein each of the covers further comprises a circuit positioned on the cover, the circuit connected to the source and releasing the moistening fluid onto the sea mammal.

19. The device of claim 18, wherein the circuit includes a tube extending across the cover and having a plurality of holes for releasing the moistening fluid.

20. The device of claim 9, wherein the cooling system comprises a reservoir for containing the fluid, the reservoir connected to covers and the pump.

21. The device of claim 9, wherein the cooling system comprises a thermoelectric engine or a refrigeration system in thermal communication with the fluid.

22. (canceled)

23. The device of claim 21, wherein the refrigeration system comprises:
a compressor compressing a heat transfer fluid;
an evaporator connected to the compressor and in thermal communication with the fluid such that the heat transfer fluid absorbs heat from the fluid, and
a condenser connected to the evaporator and the compressor, the condenser expelling the absorbed heat of the heat transfer fluid to a heat sink.

24. The device of claim 9, wherein the pump includes a marine bilge pump connected to the cooling system and connected to the covers.

25. The device of claim 9, wherein each of the covers includes a first side positioning adjacent the sea mammal and a second side positioning away from the sea mammal.

26. The device of claim 25, wherein the first side includes a fabric material, and wherein the second side includes a plastic material.

27. (canceled)

28. The device of claim 9, further comprising a unit containing at least a portion of the device.

29. The device of claim 28, wherein the unit further comprises a power source for the device.

30. The device of claim 9, further comprising a base positioning underneath the sea mammal.

31. The device of claim 9, wherein the base defines a channel for collecting a moistening fluid.

32. The device of claim 31, wherein the base defines one or more areas for distributing weight of the sea mammal.

33. A device for rescuing or transporting a sea mammal, the device comprising:
means for cooling a cooling fluid;
first means for conveying the cooling fluid in thermal communication with at least a portion of the body of the sea mammal;
second means for conveying the cooling fluid in thermal communication with at least a portion of the dorsal fin of the sea mammal;
third means for conveying the cooling fluid in thermal communication with at least a portion of the tail fin of the sea mammal; and
means for conveying a moistening fluid onto the sea mammal.

34. The device of claim 33, wherein the means for cooling the cooling fluid comprises means for absorbing beat from the cooling fluid and expelling the heat to a heat sink.

35. The device of claim 33, wherein the means for conveying the cooling fluid in thermal communication with the portion of the sea mammal comprises means for pumping the cooling fluid.

36. The device of claim 35, wherein the means for conveying the cooling fluid in thermal communication with the portion of the sea mammal comprises means for circuiting the pumped cooling fluid adjacent the portion of the sea mammal.

37. (canceled)

38. The device of claim 33, wherein the means for conveying the moistening fluid onto the sea mammal comprises means for siphoning the moistening fluid from a source.

39. The device of claim 33, wherein the means for conveying the moistening fluid onto the sea mammal comprises means for pumping the moistening fluid from a source.

40. The device of claim 33, further comprising means for supporting the sea mammal.

41. The device of claim 40, wherein the means for supporting the sea mammal further comprises means for recollecting at least a portion of the moistening fluid from the sea mammal.

42. The device of claim 40, wherein the means for supporting the sea mammal further comprises means for cooling the sea mammal.

43. The device of claim 40, wherein the means for supporting the sea mammal further comprises means for distributing weight of the sea mammal.

44. The device of claim 33, further comprising means for containing at least a portion of the device.

45. The device of claim 44, wherein the means for containing the device further comprises means for powering the device.

46. The device of claim 1, wherein the at least one body cover defines an opening for the blowhole of the sea mammal.

47. The device of claim 1, wherein the at least one body cover comprises a first body cover having a first fastener along an edge and comprises a second body cover having a second fastener along an edge, the first fastener attaching to the second fastener to join the first and second body covers along their edges.

48. The device of claim 1, wherein the at least one fin cover comprises a tail cover covering portion of the tail fin of the sea mammal.

49. The device of claim 1, wherein the at least one fin cover comprises a dorsal fin cover covering portion of the dorsal fin of the sea mammal.

50. The device of claim 49, wherein the dorsal fin cover defines a pocket for the dorsal fin of the sea mammal and comprises a fastener along an edge of the pocket to attach to a fastener on the at least one body cover.

51. The device of claim 9, wherein the at least one body cover defines another opening for the blowhole of the sea mammal.

52. The device of claim 9, wherein the at least body cover comprises a first body cover having a first fastener along an edge and comprises a second body cover having a second fastener along an edge, the first fastener attaching to the second fastener to join the first and second body covers along their edges.

53. The device of claim 9, wherein the dorsal fin cover defines a pocket for the dorsal fin of the sea mammal and comprises a fastener along an edge of the pocket to attach to a fastener on the opening of the at least one body cover.

54. The device of claim 14, wherein the tail fin cover comprises a foldable panel folding on the tail fin of the sea mammal, the foldable panel having a first portion positioning adjacent one side of the tail fin and having a second portion positioning adjacent another side of the tail fin.

55. The device of claim 54, wherein the foldable panel comprises fasteners along edges of the first and second portions such that the edges are attachable to one another when the foldable panel is folded on the tail fin of the sea mammal.
